(19) United States
(12) Patent Application Publication
(10) Pub. No.: US 2015/0197293 A1
(43) Pub. Date: Jul. 16, 2015

(54) TRACK JOINT ASSEMBLIES

(71) Applicant: Caterpillar Inc., Peoria, IL (US)

(72) Inventors: Mark S. Diekevers, Germantown Hills, IL (US); Gregory J. Kaufmann, Metamora, IL (US)

(73) Assignee: Caterpillar Inc., Peoria, IL (US)

(21) Appl. No.: 14/568,485

(22) Filed: Dec. 12, 2014

Related U.S. Application Data
(60) Provisional application No. 61/927,073, filed on Jan. 14, 2014.

(51) Int. Cl. B62D 55/088

(52) U.S. Cl. CPC B62D 55/088

(57) ABSTRACT

Disclosed are various exemplary embodiments of a track joint assembly. In one exemplary embodiment, the track joint assembly may include a first link having a first bore. The track joint assembly may also include a second link having a second bore. Additionally, the track joint assembly may include a pin extending through the first and second bores. The track joint assembly may also include a pair of seal assemblies positioned within a cavity at least partially defined by the first bore, the second bore, and the pin. The seal assemblies may form a hermetic seal between the first and second links. The track joint assembly may also include a washer positioned between the seal assemblies.

### CROSS-REFERENCE TO RELATED APPLICATION

This application claims the benefit of U.S. Provisional Patent Application No. 61/927,073, filed Jan. 14, 2014, which is hereby incorporated by reference in its entirety.

### TECHNICAL FIELD

The present disclosure relates generally to track assemblies and, more particularly, to track joint assemblies for joining links of the track assemblies.

### BACKGROUND

Many earth-working machines, such as, for example, loaders, tractors, and excavators, include tracked undercarriages to facilitate movement of the machines over ground surfaces. Such undercarriages include drive sprockets that rotate track assemblies about one or more idlers or other guiding components to propel the machines over the ground surfaces. Each track assembly includes a pair of parallel chains, each made up of a series of links, joined to each other by pins and/or bushings, which are lubricated to facilitate rotation of the track assembly. Due to extreme wear from abrasion and impacts experienced during use, undercarriage maintenance costs often constitute more than one quarter of the total costs associated with operating the earth-working machines.

U.S. Pat. No. 7,959,239 to Diekevers et al. discloses an exemplary chain assembly, which contains lubricating fluid. The chain assembly includes a plurality of outer links alternating with a plurality of inner links, and a seal member is positioned between adjoining outer and inner links to prevent the lubricating fluid from escaping the chain assembly. At least one of the links has a contact member fastened to it for engaging the seal member to inhibit wear of the seal member.

The chain assembly of the '239 patent may provide certain benefits that are particularly important for some applications. However, it may have certain drawbacks. For example, fastening contact members to the links may be complicated and costly. As another example, seal members may need to be replaced more frequently than other components, increasing maintenance costs. The disclosed embodiments may help solve these problems.

### SUMMARY

One disclosed embodiment relates to a track joint assembly. The track joint assembly may include a first link having a first bore. The track joint assembly may also include a second link having a second bore. Additionally, the track joint assembly may include a pair of seal assemblies positioned within a cavity at least partially defined by the first and second bores. The seal assemblies may form a hermetic seal between the first and second links.

Another disclosed embodiment relates to another track joint assembly. The track joint assembly may include a washer. The track joint assembly may also include a first seal assembly contacting a first side of the washer. In addition, the track joint assembly may include a second seal assembly contacting a second side of the washer.

A further disclosed embodiment relates to yet another track joint assembly. The track joint assembly may include a first link having a first bore. The track joint assembly may also include a second link having a second bore. Additionally, the track joint assembly may include a pin extending through the first and second bores. The track joint assembly may also include a pair of seal assemblies positioned within a cavity at least partially defined by the first bore, the second bore, and the pin. The seal assemblies may form a hermetic seal between the first and second links. The track joint assembly may also include a washer positioned between the seal assemblies.

### BRIEF DESCRIPTION OF THE DRAWINGS

FIG. 1 is a perspective view of a track assembly according to the present disclosure;

FIG. 2 is a cross-section of a track joint assembly of the track assembly of FIG. 1; and

FIG. 3 is a cross-section of another track joint assembly according to the present disclosure.

### DETAILED DESCRIPTION

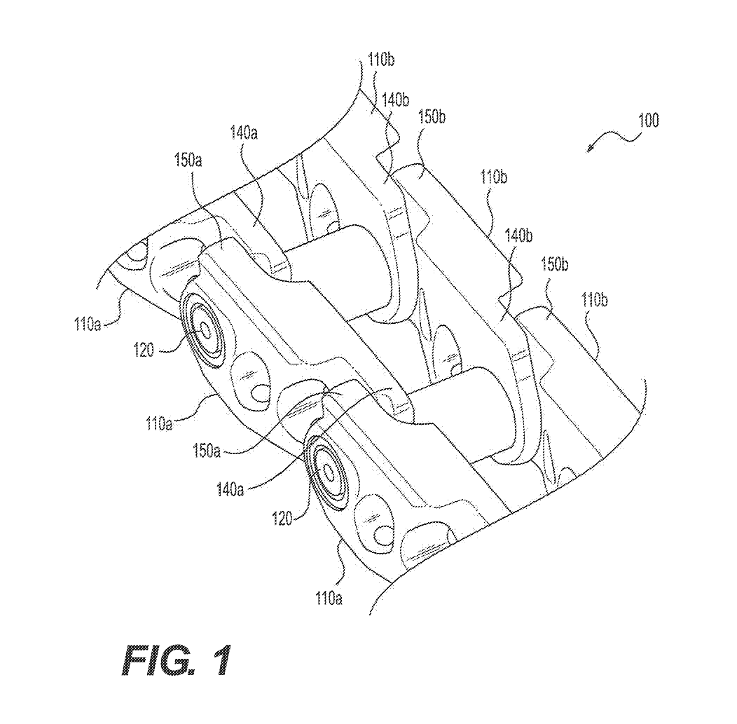

FIG. 1 illustrates an exemplary track assembly 100 for a track-type machine. For example, the track-type machine may be a loader, a tractor, an excavator, a tank, or another mobile machine having track-type traction devices. When operated, a drive sprocket of the track-type machine (not shown) may rotate track assembly 100 about one or more idlers or other guiding components (not shown) to facilitate movement of the track-type machine.

Track assembly 100 may include a series of links 110a joined to each other and to a series of links 110b by laterally disposed pins 120. As shown, links 110a and 110b may be offset links. That is, they may have inwardly offset ends 140a, 140b and outwardly offset ends 150a, 150b. An inwardly offset end 140a, 140b of each link 110a, 110b may be joined to an outwardly offset end 150a, 150b of each adjacent link 110a, 110b. In addition, an inwardly offset end 140a of each link 110a may be joined to an inwardly offset end 140b of an opposing link 110b, and an outwardly offset end 150a of each link 110a may be joined to an outwardly offset end 150b of an opposing link 110b. It should be understood, however, that links 110a and 110b need not be offset links. Rather, in some embodiments, links 110a and 110b may be inner links and outer links. In such embodiments, both ends of each opposing pair of inner links would be sandwiched between ends of opposing outer links, as is known in the art.

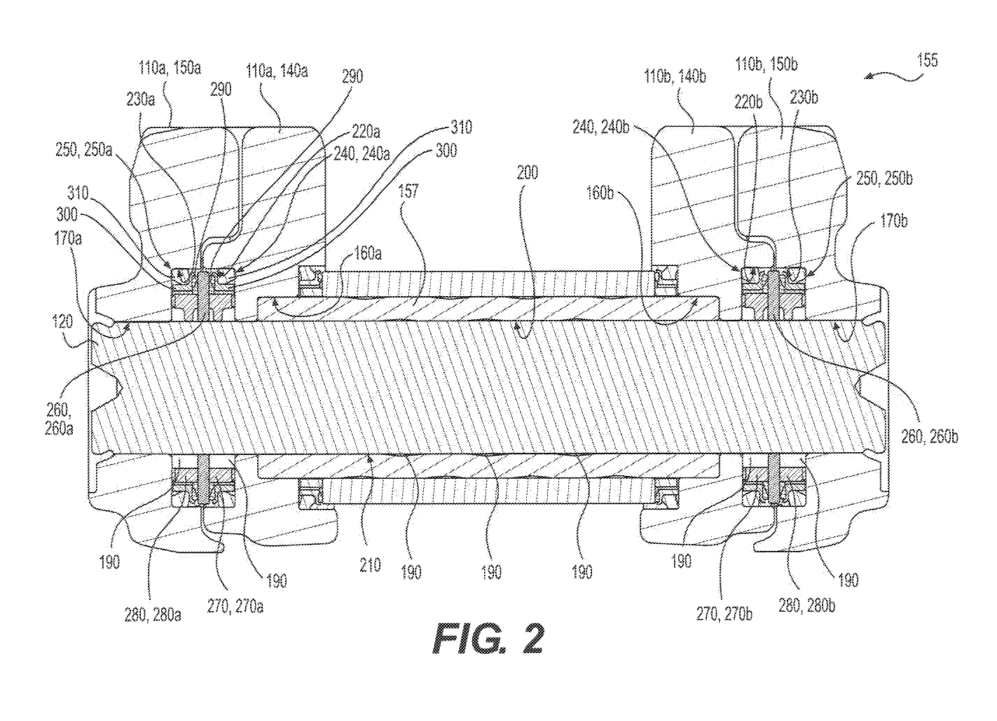

Referring to FIG. 2, an individual track joint assembly 155 of track assembly 100 may include two links 110a. joined to two links 110b, As shown, inwardly offset ends 140a, 140b of links 110a, 110b may be secured to a joint bushing 157, which may be at least partially positioned within bushing bores 160a, 160b of offset ends 140a, 140b, Similarly, outwardly offset ends 150a, 150b of links 110a, 110b may be secured to a pin 120, which may be at least partially positioned within pin bores 170a, 170b of offset ends 150a, 150b, For example, the securing may be by way of press-fits. Specifically, bushing 157 may be press-fit into bushing bores 160a, 160b, and pin 120 may be press-fit into pin bores 170a, 170b, Alternatively, the securing may he by way of welds, snap rings, or other mechanisms known in the art.

As shown, bushing 157 may be positioned coaxially around pin 120, and may rotate relative to pin 120, allowing inwardly offset ends 140a, 140b to pivot relative to outwardly offset ends 150a, 150b as track assembly 100 rotates, in order to facilitate such rotation, a lubricating fluid may be situated between bushing 157 and pin 120. The lubricating, fluid may be contained in a lubricating fluid cavity 190 at least partially defined by a generally cylindrical inner surface 200 of inner bushing 157 and a generally cylindrical outer surface 210 of pin 120 facing surface 200. Lubricating fluid cavity 190 may also be at least partially defined by seal bores 220a, 220b of inwardly offset ends 140a, 140b and seal bores 230a, 230b of outwardly offset ends 150a, 150b, all of which pin 120 extends through. As shown, seal bores 220a, 220b may be approximately the same depth as seal bores 230a, 230b. Alternatively, seal bores 220a, 220b could be deeper or shallower than seal bores 230a, 230b.

Still referring to FIG. 2, track joint assembly 155 may also include seal assemblies 240a, 240b, 250a, 250b, washers 260a, 260b, and thrust rings 270a, 270b, 280a, 280b positioned within lubricating fluid cavity 190. Seal assemblies 240a, 250a, washer 260a, and thrust rings 270a, 280a are mirror images of seal assemblies 240b, 250b, washer 260b, and thrust rings 270b, 280b, respectively, so only seal assemblies 240a, 250a, washer 260a, and thrust rings 270a, 280a are further described here.

Seal assemblies 240a, 250a may contact opposite sides of washer 260a, and may, in conjunction with washer 260a (which is positioned between seal assemblies 240a, 250a), form a hermetic seal between adjacent links 110a to retain the lubricating fluid in lubricating fluid cavity 190. As track assembly 100 rotates, seal assemblies 240a, 250a may slide against and rotate relative to washer 260a. Accordingly, washer 260a may be polished and/or formed from or coated with a material well-suited to resist wear and corrosion resulting from contact between seal assemblies 240a, 250a and washer 260a, For example, the material may be an electroless nickel coating, a nitride coating, or a carburized coating. Alternatively, the material may be a laser hardened or a thermal sprayed material.

As illustrated in FIG. 2, seal assemblies 240a, 250a may be approximately the same shape and may face in opposite directions. For example, each seal assembly 240a, 250a may include a sealing lip 290, a can ring 300, and a load ring 310. Sealing lip 290 may be a non-metallic material such as thermoplastic urethane, can ring 300 may be plastic or metal, and load ring 310 may be an elastomeric material such as a low modulus nitrile (NBR) rubber compound. Alternatively, these portions of seal assemblies 240a, 250a may be other materials. When installed and under compression, load ring 310 may transfer force to can ring 300, which may in turn transfer force to sealing lip 290, thereby causing sealing lip 290 to sealingly engage washer 260a, Such an arrangement may ensure that a coefficient of friction between seal assembly 240a and washer 260a is approximately the same as a coefficient of friction between seal assembly 250a and washer 260a. As a result, during rotation of track assembly 100, seal assemblies 240a, 250a may rotate approximately the same amount relative to washer 260a, Alternatively, seal assemblies 240a, 250b may be differently shaped, or may face in the same direction. Accordingly, it should be understood that the coefficient of friction between seal assembly 240a and washer 260a could be different from the coefficient of friction between seal assembly 250a and washer 260a in some embodiments.

As shown, seal assemblies 240a, 250a may be positioned radially outward of thrust rings 270a, 280a, allowing thrust rings 270a, 280a to, in conjunction with washer 260a (which is positioned between thrust rings 270a, 280a), transmit axial load between adjacent links 110a, while limiting axial load on seal assemblies 240a, 250a. Seal assembly 240a may be positioned entirely within seal bore 220a, and seal assembly 250a may be positioned entirely within seal bore 230a. However, it should be understood that seal assembly 240a could be positioned only partially within seal bore 220a, or seal assembly 250a could be positioned only partially within seal bore 230a, For example, although seal assemblies 240a, 250a are illustrated as being approximately the same size, they could be differently sized in some embodiments. In such embodiments, the larger of seal assemblies 240a, 250a could extend out of its respective seal bore 220a, 230a.

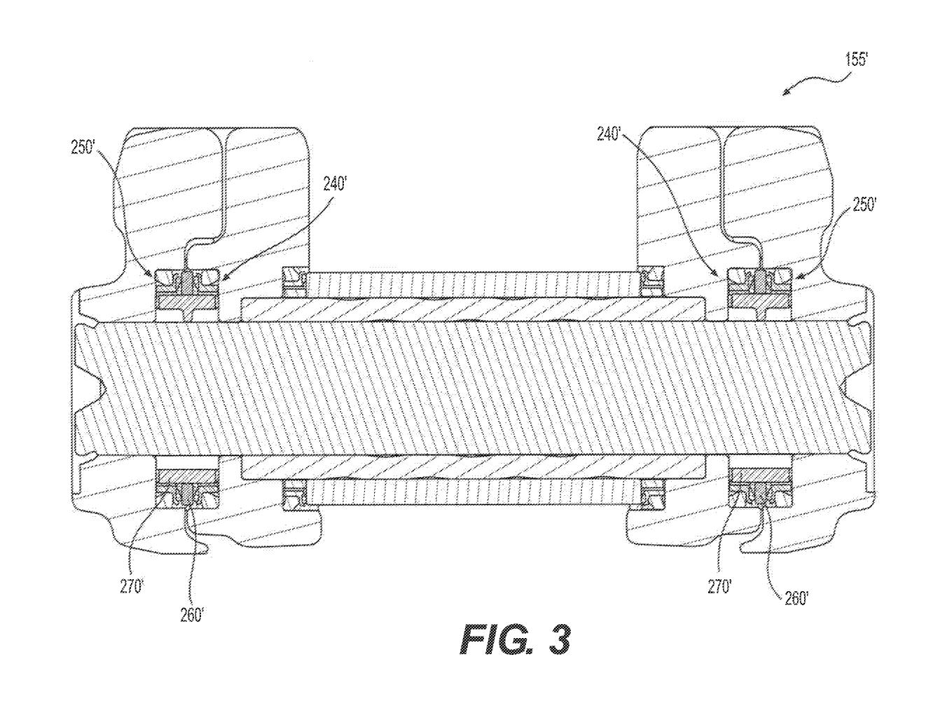

FIG. 3 illustrates another embodiment of a track joint assembly 155′ including a different thrust ring and washer configuration. Instead of having thrust rings 270, 280 corresponding to seal assemblies 240, 250 and separated by washer 260, track joint assembly 155′ may include thrust rings 270′ and washers 260′. As shown, each thrust ring 270′ may be approximately as wide as the combination of thrust rings 270, 280 and washer 260. Thus, a set of seal assemblies 240′, 250′, which may be identical to seal assemblies 240, 250, and washer 260′ may all be positioned radially outward of a single thrust ring 270′. Otherwise, track joint assembly 155′ may be identical to track joint assembly 155.

The configuration of track joint assemblies 155, 155′ is not limited to the configurations discussed above and shown in the drawings. For example, washer 260′ and thrust ring 270′ may be formed as a single unitary part. As another example, seal bores 220, 230 may be otherwise shaped. For example, instead of being generally cylindrical, as illustrated, seal bores 220, 230 may be generally conical.

### INDUSTRIAL APPLICABILITY

The disclosed track joint assemblies may be applicable to track-type machines, such as, for example, loaders, tractors, excavators, and tanks, and may facilitate movement of the machines. The disclosed track joint assemblies may have various advantages over prior art track joint assemblies. For example, manufacturing the disclosed track joint assemblies may cost less than manufacturing prior art track joint assemblies. As another example, the disclosed track joint assemblies may require less maintenance than prior art track joint assemblies. Specific advantages of the disclosed track joint assemblies will now be described.

Track joint assembly 155 may be configured to minimize the complexity and cost of its manufacture. Such minimization may be achieved by limiting the use of certain wear and corrosion- resistant materials to small, easy to handle components. For example, the use of these materials may be limited to washers 260, simplifying and reducing the cost of manufacture of other more complex components like links 110a, 110b.

Track joint assembly 155 may also be configured to minimize the maintenance associated with it. For example, track joint assembly 155 may include two seal assemblies 240a, 250a positioned between each pair of adjacent links 110a. As a result, during rotation of track assembly 100, each seal assembly 240a, 250a may rotate less than it would if it was the only seal assembly positioned between the adjacent links. This is because only the combined amount of rotation of seal assemblies 240a, 250a, not the amount of rotation of each seal assembly 240a, 250a, will match the amount of rotation between the pair of adjacent links 110a. Accordingly, the inclusion of both seal assemblies 240a, 250b may minimize wear on the seal assemblies 240a, 250b, and thereby extend their lives, reducing the amount of maintenance associated with track joint assembly 155.

It will be apparent to those skilled in the art that various modifications and variations can be made to the disclosed track joint assemblies. Other embodiments will be apparent to those skilled in the art from consideration of the specification and practice of the disclosed track joint assemblies.

It is intended that the specification and examples be considered as exemplary only, with a true scope being indicated by the following claims and their equivalents.

What is claimed is:

1. A track joint assembly, comprising:
a first link having a first bore;
a second link having a second bore; and
a pair of seal assemblies positioned within a cavity at least partially defined by the first and second bores, and forming a hermetic seal between the first and second links.

2. The track joint assembly of claim 1, including a washer positioned between the seal assemblies.

3. The track joint assembly of claim 2, including:
a first thrust ring; and
a second thrust ring, wherein:
the washer is positioned between the first and second thrust rings;
one of the seal assemblies is positioned radially outward of the first thrust ring; and
the other of the seal assemblies is positioned radially outward of the second thrust ring.

4. The track joint assembly of claim 2, including a thrust ring, wherein the washer and the seal assemblies are positioned radially outward of the thrust ring.

5. The track joint assembly of claim 2, wherein the seal assemblies are both approximately the same shape.

6. The track joint assembly of claim 5, wherein the seal assemblies face in opposite directions and contact opposite sides of the washer.

7. The track joint assembly of claim 6, wherein a coefficient of friction between one of the seal assemblies and the washer is approximately the same as a coefficient of friction between the other of the seal assemblies and the washer.

8. The track joint assembly of claim 1, wherein one of the seal assemblies is positioned entirely within the first bore.

9. The track joint assembly of claim 8, wherein the other of the seal assemblies is positioned entirely within the second bore.

10. The track joint assembly of claim 1, wherein the seal assemblies are both approximately the same size.

11. A track joint assembly, comprising:
a washer;
a first seal assembly contacting a first side of the washer; and
a second seal assembly contacting a second side of the washer.

12. The track joint assembly of claim 11, wherein the seal assemblies are both approximately the same shape and face in opposite directions.

13. The track joint assembly of claim 11, wherein a coefficient of friction between the first seal assembly and the washer is approximately the same as a coefficient of friction between the second seal assembly and the washer.

14. The track joint assembly of claim 11, wherein the seal assemblies are both approximately the same size.

15. The track joint assembly of claim 11, including:
a first thrust ring; and
a second thrust ring, wherein:
the washer is positioned between the first and second thrust rings;
the first seal assembly is positioned radially outward of the first thrust ring; and
the second seal assembly is positioned radially outward of the second thrust ring.

16. The track joint assembly of claim 11, including a thrust ring, wherein the washer and the seal assemblies are positioned radially outward of the thrust ring.

17. A track joint assembly, comprising:
a first link having a first bore;
a second link having a second bore;
a pin extending through the first and second bores;
a pair of seal assemblies positioned within a cavity at least partially defined by the first bore, the second bore, and the pin, and forming a hermetic seal between the first and second links; and
a washer positioned between the seal assemblies.

18. The track joint assembly of claim 17, wherein a coefficient of friction between one of the seal assemblies and the washer is approximately the same as a coefficient of friction between the other of the seal assemblies and the washer.

19. The track joint assembly of claim 17, including:
a first thrust ring; and
a second thrust ring, wherein:
the washer is positioned between the first and second thrust rings;
one of the seal assemblies is positioned radially outward of the first thrust ring; and
the other of the seal assemblies is positioned radially outward of the second thrust ring.

20. The track joint assembly of claim 17, including a thrust ring, wherein the washer and the seal assemblies are positioned radially outward of the thrust ring.
